(19) United States
(12) Patent Application Publication
(10) Pub. No.: US 2019/0026602 A1
(43) Pub. Date: Jan. 24, 2019

(54) Neural Network Processing Method, Apparatus, Device and Computer Readable Storage Media

(71) Applicant: Alibaba Group Holding Limited, Grand Cayman (KY)

(72) Inventors: Cong Leng, Beijing (CN); Hao Li, Hangzhou (CN); Zesheng Dou, Beijing (CN); Shenghuo ZHU, Bellevue, WA (US); Rong JIN, Okemos, WI (US)

(73) Assignee: Alibaba Group Holding Limited

(21) Appl. No.: 16/039,056

(22) Filed: Jul. 18, 2018

(30) Foreign Application Priority Data
Jul. 19, 2017 (CN) 201710592048.X

(51) Int. Cl. G06K 9/62; G06N 3/08; G06F 17/15; G06F 17/11

(52) U.S. Cl. CPC G06K 9/6257; G06F 17/11; G06F 17/15; G06N 3/08

(57) ABSTRACT

A method, an apparatus, a device and a computer readable storage media for neural network processing are disclosed. The method includes constructing a training function having a constraint for a neural network; and solving a constrained optimization based on the training function to obtain connection weights of the neural network. The neural network processing method, apparatus, device and computer readable storage media of the embodiments of the present disclosure model a problem of solving connection weights of a neural network from the perspective of an optimization problem, and can effectively find a solution for the problem of solving the connection weights of the neural network, thus being able to improve the speed of training of the neural network.

### CROSS REFERENCE TO RELATED PATENT APPLICATIONS

This application claims priority to Chinese Patent Application No. 201710592048.X, filed on 19 Jul. 2017, entitled “Neural Network Processing Method, Apparatus, Device, and Computer Readable Storage Media,” which are hereby incorporated by reference in its entirety.

### TECHNICAL FIELD

The present disclosure relates to the technical field of artificial neural networks, and particularly to neural network processing methods, apparatuses, devices, and computer readable storage media.

### BACKGROUND

Artificial Neural Networks (ANNs) are abbreviated as neural networks (NNs), and are algorithmic and mathematical models that simulate behavior features of animal neural networks for performing distributed and parallel information processing. This type of network relies on the degree of complexity of a system, and achieves a goal of processing information by adjusting mutual relationships among a large number of internal nodes.

Currently, neural network training mainly uses a heuristic algorithm for training. However, the speed of training a neural network using a heuristic algorithm is relatively slow.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide a method, an apparatus, a device and a computer readable storage media for neural network processing to improve the speed of training a neural network.

In implementations, the embodiments of the present disclosure provide a neural network processing method. The method includes constructing a training function having a constraint for a neural network; and solving a constrained optimization based on the training function to obtain connection weights of the neural network.

In implementations, the embodiments of the present disclosure provide a neural network processing apparatus. The apparatus includes a construction module used for constructing a training function having a constraint for a neural network; and a solving module used for solving a constrained optimization based on the training function to obtain connection weights of the neural network.

In implementations, the embodiments of the present disclosure provide a neural network processing device. The device includes memory used for storing executable program codes; and processor(s) used for reading the executable program codes that are stored in the memory to perform the neural network processing method provided by the embodiments of the present disclosure.

In implementations, the embodiments of the present disclosure provide a type of computer readable storage media. The computer readable storage media having computer program codes stored thereon. The computer program codes, when executed by processor(s), implement the neural network processing method provided by the embodiments of the present disclosure.

The neural network processing method, apparatus, device and computer readable storage media of the embodiments of the present disclosure model a problem of solving connection weights of a neural network from the perspective of an optimization problem, and can effectively find a solution for the problem of solving the connection weights of the neural network, thus being able to improve the speed of training of the neural network.

### BRIEF DESCRIPTION OF THE DRAWINGS

In order to describe technical solutions of the embodiments of the present disclosure in a better manner, the accompanying drawings are briefly described herein. One of ordinary skill in the art can also obtain other drawings based on these accompanying drawings without making any creative effort.

FIG. 1 shows a flowchart of a neural network processing method provided by the embodiments of the present disclosure.

FIG. 2 shows a schematic structural diagram of a neural network processing apparatus provided by the embodiments of the present disclosure.

FIG. 3 shows a structural diagram of an exemplary hardware structure of a computing device capable of implementing the neural network processing method and apparatus according to the embodiments of the present disclosure.

### DETAILED DESCRIPTION

Various features and exemplary embodiments of the present disclosure are described in detail hereinafter. In order to make the goals, the technical solutions and the advantages of the present disclosure more easily to be understood, the present disclosure is described in further detail hereinafter in conjunction with the accompanying drawings and the embodiments. It should be understood that the specific embodiments described herein are merely used for describing the present disclosure, and are not used for limiting the present disclosure. The description of the embodiments herein is merely used for the purpose of providing a better understanding of the present disclosure by illustrating examples of the present disclosure.

It should be noted that relational terms such as first and second in the present text are merely used for distinguishing one entity or operation from another entity or operation, and do not necessarily imply an existence of this type of relationship or order between these entities or operations in reality. Moreover, terms such as “include”, “contain” or any other variations thereof are intended to cover a non-exclusive inclusion. As such, a process, method, article or device including a series of elements not only includes these elements, but also includes other elements that are not explicitly listed, or elements that are inherent in the process, method, article or device. Without further limitation, an element defined by a phrase “including . . . ” does not exclude a process, method, article or device including this element from further including an addition of the same element.

Existing neural networks are mainly trained using a heuristic algorithm. However, the speed of training a neural network using a heuristic algorithm is relatively slow. Accordingly, the embodiments of the present disclosure provide a method, an apparatus, a device and a computer readable storage media of processing a neural network based on a concept of solving a constrained optimization problem, to train the neural network, thus improving the speed of training of the neural network.

A neural network processing method provided by the embodiments of the present disclosure is first described in detail hereinafter.

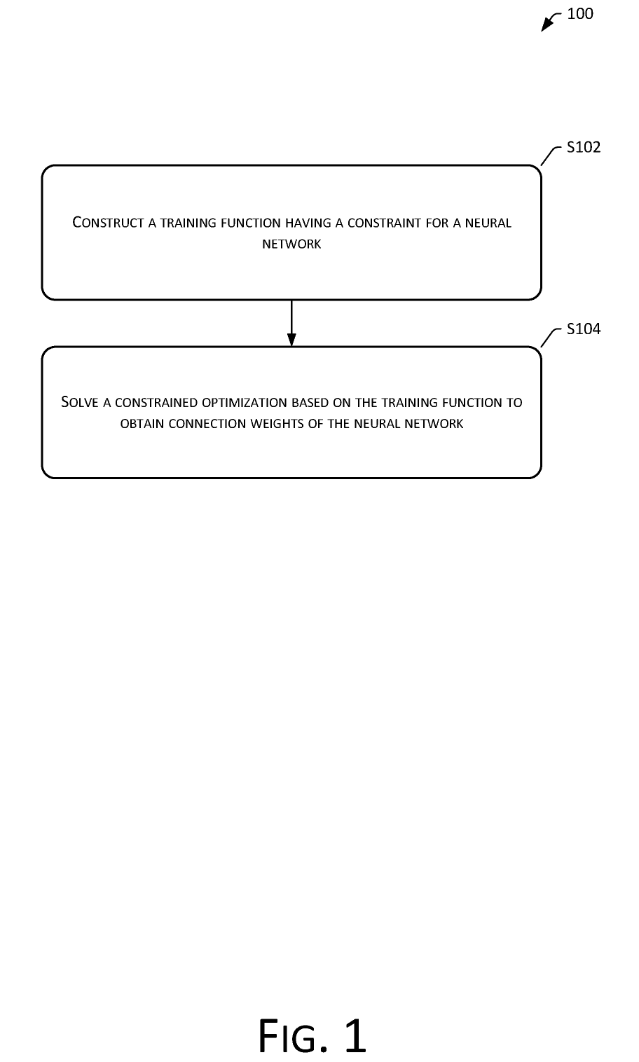

As shown in FIG. 1, FIG. 1 shows a flowchart of a neural network processing method 100 provided by the embodiments of the present disclosure, which may include:

S102: Construct a training function having a constraint for a neural network.

S104: Solve a constrained optimization based on the training function to obtain connection weights of the neural network.

A connection weight is a value used for measuring the strength of a connection between an upper layer neuron and a lower layer neuron.

For example, a neural network of the embodiments of the present disclosure is represented as f(W), where W={W₁, W₂, . . . , W_{d}}, Wᵢ is an ith connection weight of the neural network.

In an embodiment of the present disclosure, if a neural network is a three-dimensional neural network, and initial values of connection weights thereof are individually −1, 0, and 1, training function having a constraint that is constructed for this three-dimensional neural network may be represented as follows:

$${min}_{W} f ( W )$$

$$s . t . W ∈ C = {\{ - 1 , 0 , + 1 \}}^{d}$$

s. t. WϵC={−1, +1}^{d} represents that values of connection weights are restricted within a connection weight space C, where the connection weight space C includes −1, 0, and 1. In other words, a value of a connection weight W can only be 1, 0, or +1.

It should be noted that the above neural network is a discrete neural network. Apparently, the embodiments of the present disclosure are not limited to processing for discrete neural networks. In other words, the embodiments of the present disclosure can also be processing for non-discrete neural network.

It can be understood that a constraint corresponding to a discrete neural network can be represented using an equality, and a constraint corresponding to a non-discrete neural network can be represented using an inequality.

When connection weights of a neural network is obtained by solving a constrained optimization based on a training function, a solving algorithm used for solving the constrained optimization may be any one of the following algorithms: a penalty function algorithm, a multiplier algorithm, a projected gradient algorithm, a reduced gradient algorithm, or a constrained variable-scale algorithm.

In implementations, due to different settings of different solving algorithms for a constrained optimization problem (i.e., some solving algorithms only suitable for solving inequality constrained problems, some solving algorithms only suitable for solving equality constrained problems, some solving algorithms suitable for solving both inequality constrained problems and equality constrained problems), which type of solving algorithm is used can be determined based on the constraint (i.e., a solving algorithm used for solving the constrained optimization is determined) before the embodiments of the present disclosure solve the constrained optimization based on the training function to obtain the connection weights of the neural network.

In implementations, solve the constrained optimization based on the training function to obtain the connection weights of the neural network may include performing equivalent transformation for the training function based on an indicator function and a consistency constraint; decomposing the training function that has gone through the equivalent transformation using ADMM (i.e., Alternating Direction Method of Multipliers); and solving the connection weights of the neural network for each sub-problem obtained after the decomposition.

In implementations, performing the equivalent transformation for the training function based on the indicator function and the consistency constraint may include decoupling the training function.

In implementations, solving the connection weights of the neural network for each sub-problem obtained after the decomposition may include performing an iterative computation for each sub-problem obtained after the decomposition, to obtain the connection weights of the neural network.

The indicator function of the embodiments of the present disclosure is represented as follows:

$${I}_{C} ( X ) = \{ \begin{matrix}0 & if X ∈ C \\ ∞ & if X ∉ C\end{matrix} \qquad ( 1 )$$

The indicator function I_{c}(X) is a function defined on a set X, representing which elements belonging to a subset C.

The embodiments of the present disclosure introduce a new variable G, and set the consistency constraint W=G. Combining with the above indicator function I_{c}(X), the equivalent transformation of the training function of the embodiments of the present disclosure is:

$$\begin{matrix}{min}_{W , G} f ( W ) + {I}_{C} ( G ) & ( 2 ) \\ s . t . W = G & ( 3 )\end{matrix}$$

A corresponding augmented Lagrange multiplier is represented as:

$${L}_{ρ} ( W , G , λ ) = f ( W ) + {I}_{C} ( G ) + \frac{ρ}{2} \vert \vert W - G {\vert \vert}^{2} + < λ , W - G > \qquad ( 4 )$$

λ is a Lagrange multiplier, and p is a regularization coefficient.

For the equations (2) and (3), the indicator function is applied on G, and initial connection weights are not constrained herein. Through the indicator function I_{c}(X) and the consistency constraint W=G, the connection weights and the constraint are decoupled, i.e., the training function is decoupled.

Based on ADMM, the training function is decomposed into the following three sub-problems after the equivalent transformation:

$$\begin{matrix}{W}^{k + 1} \text{:} = {arg min}_{W} {L}_{ρ} ( w , {G}^{k} , {λ}^{k} ) & ( 5 ) \\ {G}^{k + 1} \text{:} = {arg min}_{G} {L}_{ρ} ( {W}^{k + 1} , G , {λ}^{k} ) & ( 6 ) \\ {λ}^{k + 1} \text{:} = {λ}^{k} + ρ ( {W}^{k + 1} - {G}^{k + 1} ) & ( 7 )\end{matrix}$$

In the equations (5), (6) and (7), k is the number of rounds of iteration.

In an embodiment of calculation, the equations (5), (6) and (7) are iteratively solved. In one round of iteration, the following process is performed:

first, finding a non-constrained solution of the connection weights W according to the equation (5): finding a solution of W (i.e., W^{k+1}) without a constraint in the k+1^{th} based on G (i.e., G^{k}) and λ (i.e., λ^{k}) of the k^{th} round;

then, finding a solution of G having a constraint according to the equation (6): finding a solution of G (i.e., G^{k+1}) with a constraint in the k+1^{th} round based on A (i.e., λ^{k}) and W (i.e., W^{k+1}) that is obtained from the equation (5), of the k^{th} round;

then, updating A according to the equation (7): solving and updating λ (i.e., λ^{k+1}) in the k+1^{th} round based on λ(i.e., λ^{k}), W (i.e., w^{k+1}) that is obtained from the equation (5), and G (i.e., G^{k+1}) that is obtained from the equation (6), of the k^{th} round; and

finally, finding a solution of G which is the connection weights.

It should be noted that solving the above equations is very easy, and therefore the speed of training a neural network can be improved.

The neural network processing method of the embodiments of the present disclosure models a problem of solving connection weights of a neural network from the perspective of an optimization problem, and can effectively find a solution for the problem of solving the connection weights of the neural network, thus being able to improve the speed of training of the neural network.

Currently, a processor needs to perform a large number of multiplication operations when a neural network computation is performed. The processor needs to invoke a multiplier for one multiplication operation, and couple two operands of the multiplication operation into the multiplier, for the multiplier to output a result. This is especially true when the invoked multiplier is a floating-point multiplier. The floating-point multiplier needs to obtain a sum of exponents of the two operands, multiply mantissas of the two operands, and then format and round off a result thereof in order to obtain a final result, having a relatively slow speed of neural network computation.

In order to improve the computation speed of a neural network, the embodiments of the present disclosure also provide a neural network computation method.

In implementations, connection weights solved by the neural network processing method provided in the embodiments of the present disclosure are powers of 2. For computations of such neural network, a process of the neural network computation method provided by the embodiments of the present disclosure is given as follows. A processor may first obtain computation rule(s) of the neural network, wherein the computation rule(s) of the neural network define whether a multiplication operation or an addition operation between operands exists. For a multiplication operation in the computation rule(s) of the neural network, a source operand corresponding to the multiplication operation is inputted into a shift register, and a shift operation is performed according to the connection weights corresponding to the multiplication operation. The shift register outputs a target result operand as a result of the multiplication operation.

In implementations, connection weights corresponding to the multiplication operation are 2 to the power of N, N being an integer greater than zero. A source operand corresponding to the multiplication operation may be inputted into a shift register, shifting to the left by N time. Alternatively, the source operand corresponding to the multiplication operation may also be inputted into a left shift register, shifting by N time.

In implementations, connection weights corresponding to the multiplication operation are 2 to the power of minus N, N being an integer greater than zero. A source operand corresponding to the multiplication operation may be inputted into a shift register, shifting to the right by N time. Alternatively, the source operand corresponding to the multiplication operation may also be inputted into a right shift register, shifting by N time.

In order to accurately shift a source operand, the number of bits of the source operand in the embodiments of the present disclosure is not greater than the number of bits of a value that is registered by the shift register. For example, the number of bits that can be registered in a shift register is 8, i.e., the shift register is an 8-bit shift register, and the number of bits of a source operand is not greater than 8.

The processor in the embodiments of the present disclosure may be a processor based on X86 architecture, a processor based on an Advanced RISC Machine (ARM) architecture, or a microprocessor based on a Microprocessor within Interlocked Pipeline Stages (MIPS) architecture, or a processor based on a dedicated architecture, such as a processor based on a Tensor Processing Unit (TPU) architecture.

The processor in the embodiments of the present disclosure may be a general-purpose processor, or may also be a customized processor. A customized processor refers to a processor dedicated to neural network computing and having a shift register without a multiplier, i.e., the processor is a processor that does not include a multiplication unit.

The embodiments of the present disclosure provide a neural network computing method, which replaces a multiplication operation in a neural network with a shift operation, and performs a neural network computation through a shift operation so as to improve the speed of the neural network computation.

If neural network connection weights are −4, −2, −1, 0, 1, 2, and 4 respectively, the connection weights can all be represented by 4-bit signed fixed-point integers. Compared to a storage space occupied by the connection weights in a form of 32-bit single-precision floating-point numbers, a compression of the storage space by 8 times is achieved. Compared to a storage space occupied by the connection weights in a form of 64-bit double-precision floating-point numbers, a compression of the storage space by 16 times is achieved. Since the connection weights of the neural network provided in the embodiments of the present disclosure occupy a less storage space, a model of an entire neural network is also smaller. The neural network can be downloaded into a mobile terminal device, and the mobile terminal device performs computation for the neural network. The mobile terminal device does not need to upload data to a cloud server, and can process the data locally in real time, thus reducing the delay in processing the data and the computing pressure of the cloud server.

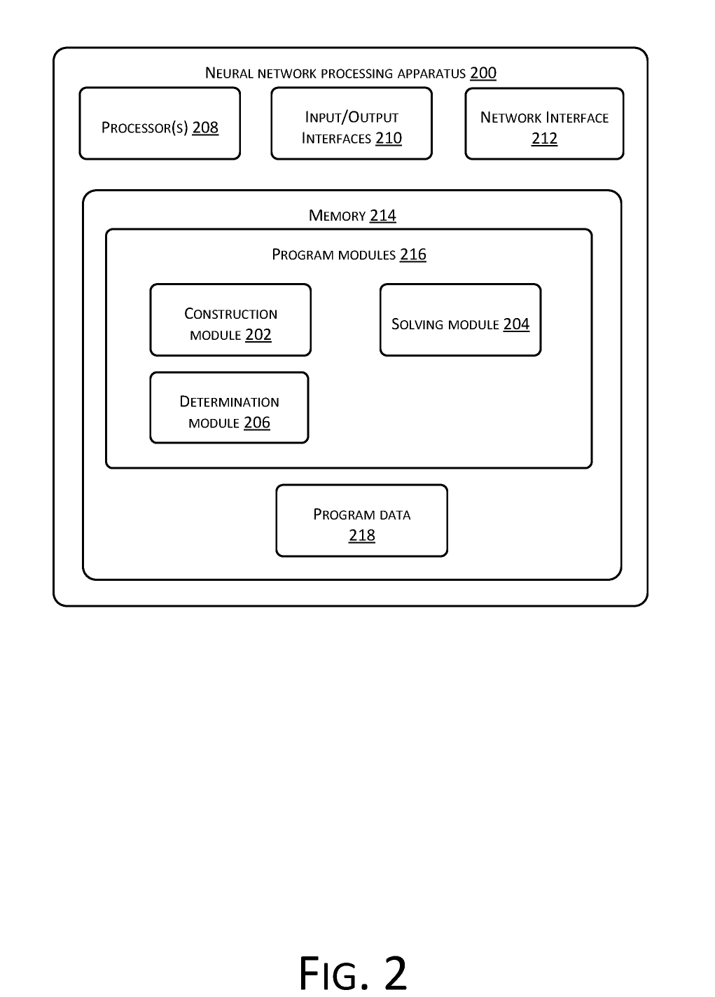

Corresponding to the foregoing method embodiment, the embodiments of the present disclosure further provide a neural network processing apparatus. As shown in FIG. 2, FIG. 2 shows a schematic structural diagram of a neural network processing apparatus 200 provided by the embodiments of the present disclosure. In implementations, the neural network processing apparatus 200 may include one or more computing devices. In implementations, the neural network processing apparatus 200 may be a part of one or more computing devices, e.g., implemented or run by the one or more computing devices. In implementations, the one or more computing devices may be located in a single place or distributed among a plurality of network devices over a network. By way of example and not limitation, the neural network processing apparatus 200 may include a construction module 202 configured to construct a training function with a constraint for a neural network; and a solving module 204 configured to solve a constrained optimization based on the training function to obtain connection weights of the neural network.

The neural network processing apparatus 200 provided in the embodiments of the present disclosure may be used for processing a discrete neural network, and may also be used for processing a non-discrete neural network. Therefore, when the solving module 204 of the embodiments of the present disclosure finds a solution of a constrained optimization, a solving algorithm that is used may be any one of the following algorithms: a penalty function algorithm, a multiplier algorithm, a projected gradient algorithm, a reduced gradient algorithm, or a constrained variable-scale algorithm.

In implementations, due to different settings of different solving algorithms for a constrained optimization problem (i.e., some solving algorithms only suitable for solving inequality constrained problems, some solving algorithms only suitable for solving equality constrained problems, some solving algorithms suitable for solving both inequality constrained problems and equality constrained problems), the neural network processing apparatus of the embodiments of the present disclosure may also include a determination module 206 configured to determine a solving algorithm used for solving the constrained optimization based on the constraint of the training function.

In implementations, the solving module 204 includes a transformation unit configured to perform equivalent transformation for the training function based on an indicator function and a consistency constraint; a decomposition unit configured to decompose the training function that has gone through the equivalent transformation using ADMM; and a solving unit configured to solve the connection weights of the neural network for each sub-problem that is obtained after the decomposition.

In implementations, performing the equivalent transformation for the training function by the transformation unit may include decoupling the training function.

In implementations, solving the connection weights of the neural network by the solving unit may include performing an iterative calculation for each sub-problem that is obtained after the decomposition, to obtain the connection weights of the neural network.

In implementations, the neural network processing apparatus 200 may also include one or more processors 208, an input/output (I/O) interface 210, a network interface 212, and memory 214.

The memory 214 may include a form of computer readable media such as a volatile memory, a random access memory (RAM) and/or a non-volatile memory, for example, a read-only memory (ROM) or a flash RAM. The memory 214 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 214 may include program modules 216 and program data 218. The program modules 216 may include one or more of the modules as describe above.

Details of various portions of the neural network processing apparatus of the embodiments of the present disclosure are similar to the described neural network processing method of the embodiments of the present disclosure, and are not repeatedly described by the embodiments of the present disclosure herein.

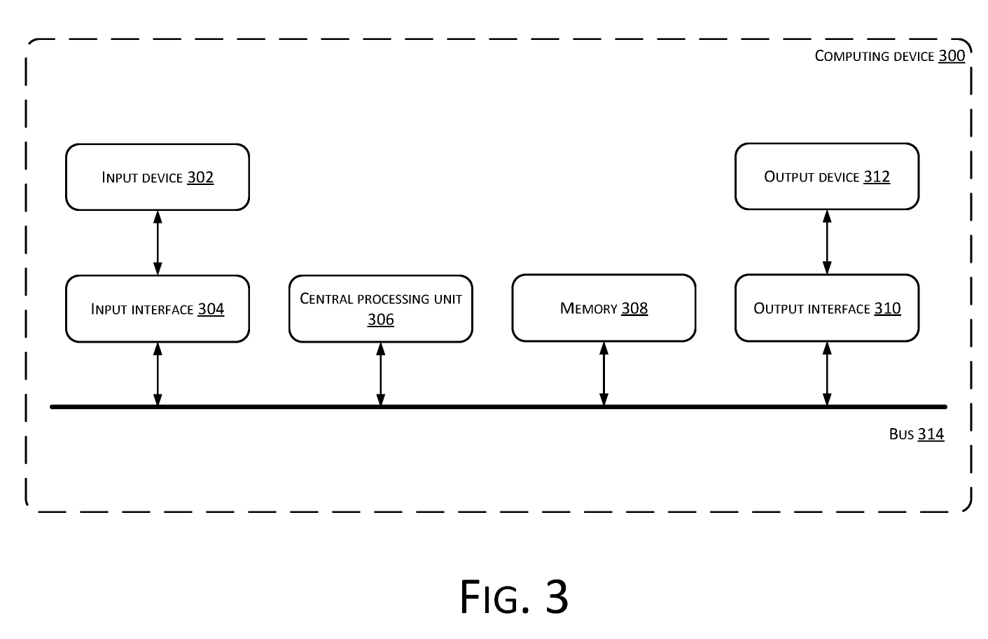

FIG. 3 shows a structural diagram of an exemplary hardware architecture of a computing device capable of implementing the neural network processing method and apparatus according to an embodiment of the present disclosure. As shown in FIG. 3, the computing device 300 includes an input device 302, an input interface 304, a central processing unit 306, memory 308, an output interface 310, and an output device 312. The input interface 304, the central processing unit 306, the memory 308, and the output interface 310 are connected to each other through a bus 314. The input device 302 and the output device 312 are connected through the input interface 304 and the output interface 310 respectively to the bus 314, and then connected to other components of the computing device 300.

Specifically, the input device 302 receives input information from outside, and transmits the input information to the central processing unit 306 via the input interface 304. The central processing unit 306 processes the input information to generate output information according to computer-executable instructions stored in the memory 308. The output information is temporarily or permanently stored in the memory 308, and the output information is then outputted to the output device 312 through the output interface 310. The output device 312 outputs the output information to the outside of the computing device 300 for use by a user.

In other words, the computing device shown in FIG. 3 may also be implemented as a neural network processing device. The neural network processing device may include memory storing computer executable instructions, and processor(s). When executing the computer executable instructions, the processor(s) can implement the neural network processing method and apparatus described in conjunction with FIGS. 1 and 2. The processor(s) may communicate with a neural network to execute computer-executable instructions based on relevant information from the neural network, thereby implementing the neural network processing method and apparatus described in conjunction with FIGS. 1 and 2.

The embodiments of the present disclosure further provide a computer-readable storage media. The computer storage media stores computer program instructions. When the computer program instructions are executed by processor(s), the neural network processing method provided by the embodiments of the present disclosure is implemented.

It should be clear that the invention is not limited to the specific configurations and processes described in the foregoing text and shown in the figures. For the sake of brevity, a detailed description of known methods is omitted herein. In the embodiments described above, a number of specific steps have been described and illustrated as examples. However, the processes of the methods of the present disclosure are not limited to these specific steps that are described and shown. After understanding the spirit of the present disclosure, one skilled in the art can make various changes, modifications and additions thereto, or changes to orders of the steps.

The functional blocks shown in the block diagrams described above may be implemented as hardware, software, firmware, or a combination thereof. When implemented in hardware, it may be, for example, an electronic circuit, an application specific integrated circuit (ASIC), suitable firmware, a plug-in, a functional card, and the like. When implemented in software, the elements of the present disclosure are programs or code segments that are used for performing the required tasks. The programs or code segments may be stored in a machine-readable media or transmitted over a transmission media or communication link via a data signal carried in a carrier wave. The “machine-readable media” may include any media that is capable of storing or transmitting information. Examples of the machine-readable media include an electronic circuit, a semiconductor memory device, a ROM, a flash memory, an erasable ROM (EROM), a floppy disk, a CD-ROM, an optical disk, a hard disk, a fiber optic media, a radio frequency (RF) link, and the like. The code segments may be downloaded via a computer network such as the Internet, an intranet, or the like.

It should also be noted that the exemplary embodiments mentioned in the present disclosure describe some methods or systems based on a series of steps or apparatuses. However, the present disclosure is not limited to the orders of the above steps. In other words, the steps may be performed in the orders mentioned in the embodiments, or may be different from the orders in the embodiments. Alternatively, a number of steps may be performed simultaneously.

The foregoing descriptions are merely specific implementations of the present disclosure. One skilled in the art can clearly understand that specific working processes of the above-described systems, modules and units may refer to corresponding processes of the foregoing method embodiments for the convenience and conciseness of description, and are not repeatedly described herein. It should be understood that the scope of protection of the present disclosure is not limited thereto. Any person skilled in the art can easily conceive various equivalent modifications or replacements within the technical scope disclosed by the present disclosure. These modifications or replacements should be covered in the scope of protection of the present disclosure.

The present disclosure can be further understood using the following clauses.

Clause 1:

A neural network processing method, wherein the method comprises: constructing a training function with a constraint for a neural network; and finding a solution of a constrained optimization solution based on the training function to obtain connection weights of the neural network.

Clause 2:

The method according to Clause 1, wherein a solving algorithm used for solving the constrained optimization is any one of the following algorithms: a penalty function method, a multiplier method, a projected gradient method, a reduced gradient method, or a constrained variable-scale method.

Clause 3:

The method according to Clause 1, wherein before finding the solution of the constrained optimization solution based on the training function to obtain the connection weights of the neural network, the method further comprises: determining a solving algorithm used for solving the constrained optimization based on the constraint of the training function.

Clause 4:

The method according to Clause 1, wherein finding the solution of the constrained optimization solution based on the training function to obtain the connection weights of the neural network comprises: performing equivalent transformation for the training function based on an indication function and a consistency constraint; decomposing the equivalently transformed training function using an alternating direction method of multipliers (ADMM); and solving the connection weights of the neural network for sub-problems obtained after the decomposing.

Clause 5:

The method according to Clause 4, wherein performing the equivalent transformation for the training function based on the indication function and the consistency constraint comprises decoupling the training function.

Clause 6:

The method according to Clause 4, wherein solving the connection weights of the neural network for the sub-problems obtained after the decomposing comprises performing iterative computations of the sub-problems obtained after the decomposing to obtain the connection weights of the neural network.

Clause 7:

A neural network processing apparatus, wherein the apparatus comprises: a construction module configured to construct a training function with a constraint for a neural network; a solving module configured to solve a constrained optimization based on the training function to obtain connection weights of the neural network.

Clause 8:

The apparatus according to Clause 7, wherein a solving algorithm used for solving the constrained optimization is any one of the following algorithms: a penalty function method, a multiplier method, a projected gradient method, a reduced gradient method, or a constrained variable-scale method.

Clause 9:

The apparatus of Clause 7, wherein the apparatus further comprises a determination module configured to determine a solving algorithm used for solving the constrained optimization according to the constraint of the training function.

Clause 10:

The apparatus according to Clause 7, wherein the solving module comprises: a transformation unit configured to perform an equivalent transformation on the training function based on an indication function and a consistency constraint; a decomposition unit configured to decompose the equivalently transformed training function using an alternating direction method of multipliers (ADMM); and a solving unit configured to solve the connection weights of the neural network for sub-problems obtained after the decomposition.

Clause 11:

The apparatus according to Clause 10, wherein performing the equivalent transformation on the training function by the transformation unit comprising decoupling the training function.

Clause 12:

The apparatus according to Clause 10, wherein solving the connection weights of the neural network by the solving unit comprises performing iterative computations of the sub-problems obtained after the decomposing to obtain the connection weights of the neural network.

Clause 13:

A neural network processing device, wherein the device comprises memory and a processor, the memory configured to store executable program codes, and the processor configured to read the executable program codes stored in the memory for performing the neural network processing method according to any one of Clauses 1-6.

Clause 14:

A computer readable storage media, wherein computer program instructions are stored on the computer storage media, and the computer program instructions, when executed by a processor, implement the neural network processing method according to any one of Clauses 1-6.

What is claimed is:

1. A method implemented by one or more computing devices, the method comprising:
constructing a training function with a constraint for a neural network; and
finding a solution of a constrained optimization solution based on the training function to obtain connection weights of the neural network.

2. The method according to claim 1, wherein a solving algorithm used for solving the constrained optimization comprises one of a penalty function method, a multiplier method, a projected gradient method, a reduced gradient method, or a constrained variable-scale method.

3. The method according to claim 1, further comprising determining a solving algorithm used for solving the constrained optimization based on the constraint of the training function before finding the solution of the constrained optimization solution based on the training function to obtain the connection weights of the neural network.

4. The method according to claim 1, wherein finding the solution of the constrained optimization solution based on the training function to obtain the connection weights of the neural network comprises:
performing equivalent transformation for the training function based on an indication function and a consistency constraint;
decomposing the equivalently transformed training function; and
solving the connection weights of the neural network for sub-problems obtained after the decomposing.

5. The method according to claim 4, wherein performing the equivalent transformation for the training function based on the indication function and the consistency constraint comprises decoupling the training function.

6. The method according to claim 4, wherein solving the connection weights of the neural network for the sub-problems obtained after the decomposing comprises performing iterative computations of the sub-problems obtained after the decomposing to obtain the connection weights of the neural network.

7. The method according to claim 4, wherein the equivalently transformed training function is decomposed using an alternating direction method of multipliers (ADMM).

8. An apparatus implemented by one or more computing devices comprising one or more processors and memory, the apparatus comprising:
a construction module stored in the memory and executed by the one or more processors that is configured to construct a training function with a constraint for a neural network;
a solving module stored in the memory and executed by the one or more processors that is configured to solve a constrained optimization based on the training function to obtain connection weights of the neural network.

9. The apparatus according to claim 8, wherein a solving algorithm used for solving the constrained optimization is any one of the following algorithms: a penalty function method, a multiplier method, a projected gradient method, a reduced gradient method, or a constrained variable-scale method.

10. The apparatus of claim 8, further comprising a determination module configured to determine a solving algorithm used for solving the constrained optimization according to the constraint of the training function.

11. The apparatus according to claim 8, wherein the solving module comprises:
a transformation unit configured to perform an equivalent transformation on the training function based on an indication function and a consistency constraint;
a decomposition unit configured to decompose the equivalently transformed training function;
a solving unit configured to solve the connection weights of the neural network for sub-problems obtained after the decomposition.

12. The apparatus according to claim 11, wherein performing the equivalent transformation on the training function by the transformation unit comprising decoupling the training function.

13. The apparatus according to claim 11, wherein solving the connection weights of the neural network by the solving unit comprises performing iterative computations of the sub-problems obtained after the decomposing to obtain the connection weights of the neural network.

14. The apparatus according to claim 11, wherein the decomposition unit configured to decompose the equivalently transformed training function using an alternating direction method of multipliers (ADMM).

15. One or more computer readable media storing executable instructions that, when executed by one or more processors, cause the one or more processors to perform acts comprising:
constructing a training function with a constraint for a neural network; and
finding a solution of a constrained optimization solution based on the training function to obtain connection weights of the neural network.

16. The one or more computer readable media according to claim 15, wherein a solving algorithm used for solving the constrained optimization comprises one of a penalty function method, a multiplier method, a projected gradient method, a reduced gradient method, or a constrained variable-scale method.

17. The one or more computer readable media according to claim 15, the acts further comprising determining a solving algorithm used for solving the constrained optimization based on the constraint of the training function before finding the solution of the constrained optimization solution based on the training function to obtain the connection weights of the neural network.

18. The one or more computer readable media according to claim 15, wherein finding the solution of the constrained optimization solution based on the training function to obtain the connection weights of the neural network comprises:
performing equivalent transformation for the training function based on an indication function and a consistency constraint;
decomposing the equivalently transformed training function using an alternating direction method of multipliers (ADMM); and
solving the connection weights of the neural network for sub-problems obtained after the decomposing.

19. The one or more computer readable media according to claim 18, wherein performing the equivalent transformation for the training function based on the indication function and the consistency constraint comprises decoupling the training function.

20. The one or more computer readable media according to claim 18, wherein solving the connection weights of the neural network for the sub-problems obtained after the decomposing comprises performing iterative computations of the sub-problems obtained after the decomposing to obtain the connection weights of the neural network.
